(19) United States
(12) Patent Application Publication
(10) Pub. No.: US 2006/0238314 A1
(43) Pub. Date: Oct. 26, 2006

(54) Security system with multi-power mode remote control communications

(75) Inventors: Minas Minassian, Vista, CA (US); Jerry Wayne Birchfield, Vista, CA (US)

Correspondence Address: Directed Electronics, One Viper Way, Vista, CA, 92081, US

(73) Assignee: DEI HEADQUARTERS, INC., Vista, CA (US)

(21) Appl. No.: 11/110,136

(22) Filed: Apr. 20, 2005

(51) Int. Cl. B60R 25/10

(52) U.S. Cl. 340/426.13; 340/426.36

(57) ABSTRACT

A remote control (RC) device and base station of a security system communicate automatic passive remote control commands at a lower power level than the level used to transmit other information. Lowering the power level of the passive remote control transmissions from the RC device decreases energy consumption and improves battery life. Additionally, the range of the automatic commands is shortened, potentially avoiding some unwanted door lock activations, security system arming and disarming events, and similar occurrences. At the same time, the range of the user-entered commands does not suffer. In embodiments where the RC device sends passive remote control commands in response to periodic interrogatory transmissions from the base station, the power level of the interrogatory transmissions is lower than the power level of other transmissions. Thus, frequency of unwanted door lock activations and arming/disarming events is decreased, while the range of other transmissions from the base station is unchanged.

### FIELD OF THE INVENTION

The present invention relates generally to security, alarm, and convenience systems, and, more particularly, to remotely controlled vehicular and other security systems with automatic disarming, deactivation, passive remote control, keyless entry, and similar features.

### BACKGROUND

Security and alarm systems are known. Security systems are often used to secure a perimeter or an object against theft, tampering, vandalism, invasion, unauthorized use or access, and other kinds of trespass. The secured object or perimeter may be, for example, a vehicle or a building. In addition to controlling alarm activation, engine starter, and engine computer, a typical security system designed for automotive applications often includes or controls various safety and convenience features, such as power door locks, power windows, and entertainment system installed in the vehicle.

Many automotive security systems include a small hand-held remote control device, such as a key-fob, that allows the system's user to perform various operations remotely. For example, the remote control device may arm and disarm the security system, lock and unlock the doors and trunk, activate the siren, start the engine, and perform other functions when corresponding commands are entered by the user via the remote control device. If the security system is configured so that the remote control device can be used to unlock doors of an automobile without the capability to operate any other features, the system effectively becomes a keyless entry device.

It is known in the art to automate the remote control function of a remote control device. For example, a hand-held remote control device may be configured to transmit periodically a command that unlocks doors and disarms the security system. The passive remote control command may be transmitted by the remote control device automatically. The command may also be transmitted in response to receipt by the remote control device of a “feeler” or interrogatory transmission that the base station periodically sends to the remote control device. Alternatively, the remote control device may send the initial interrogatory transmission to the base station, and transmit the passive remote control command after a “handshake” with the base station during which the base station verifies the identity of the remote control device. The doors would then automatically unlock and the system would disarm when the user carrying the hand-held device approaches the automobile. This feature, however implemented, is known as “passive” remote control. The system is passive in the sense that it unlocks doors and disarms itself without any deliberate user action, other than approaching the automobile.

The time period between successive “unlock doors” and/or “disarm” command transmissions (i.e., “keyless entry” or “passive remote control” command transmissions) may vary widely. The period between these transmissions may be preset at the factory, or it may be user- or installer-configurable, and it may lie within broad time limits. But convenience considerations generally dictate that the transmissions take place often enough so that the doors would be unlocked by the time a user walking at a brisk pace approaches the automobile and attempts to open a door.

Each transmission, including command and interrogatory transmissions, consumes electrical energy in addition to the energy consumed in the device's quiescent state between transmissions. The hand-held device is typically a portable device powered by a battery, for example, a primary or a secondary cell. Because the size of a typical hand-held device is small, the batteries used in such a device are also small, with rather limited energy storage capacity. To prolong battery life, it is desirable to limit the power dissipated by the hand-held device, including the power used for periodic interrogatory or command transmissions used for implementing passive remote control functionality. Reduction in transmitted power would also reduce the effective range of the passive remote control feature.

There are other reasons to limit the effective range of the passive remote control feature, which apply regardless of whether the interrogatory transmissions are sent by the remote control device or the base station. Generally, it is desirable to unlock automobile doors automatically only when the user is in the immediate vicinity of the automobile, but not when the user is relatively far from the automobile. Automatically unlocking the doors and disarming the security system when the user cannot see the automobile leaves the automobile unprotected and accessible before the user can prevent unauthorized access. Even worse, accidental unlocking of the doors after the user has locked the doors and walked away may leave the automobile unprotected for a prolonged period. Moreover, a user may be annoyed by constant locking and unlocking of doors and arming and disarming of the security system when the automobile is parked in the driveway or garage of the user's home and the keychain with the hand-held device is stored in a safe place.

To remedy this problem, a hand-held remote control device of one prior art system uses a movement sensor, such as a “shaker” element that includes a weight located by a spring so that acceleration of the sensor creates movement of the weight with respect to the body of the sensor. As long as the sensor detects that the remote control device is moving, the remote control device transmits the passive remote control command periodically, either automatically or in response to handshakes performed after the initial (interrogatory) transmissions. When the movement stops for a predetermined period of time, the transmissions also stop, saving power and preventing undesired unlocking/disarming events described above. Such solution, however, has a number of disadvantages.

First, this approach necessitates inclusion of a movement sensor in the hand-held device, increasing both the cost and size of the device. Second, power savings are not realized when the user is continually moving. Third, the user may keep the hand-held device in a pocket while moving around the house, causing the undesirable locking and unlocking of doors, and arming and disarming of the security system. Therefore, it may still be desirable to limit the effective range of passive remote control command transmissions even in the systems where the remote control device includes a movement sensor.

Another possible approach to the problems described above is to decrease the power transmitted by the hand-held device, so that the device functions only within a relatively close range of its base station. Unfortunately, a uniform reduction in the transmitted power of the hand-held device also limits the range of the non-passive transmissions, that is, transmissions initiated by the user's commands. The reduction also affects the reliability of active (i.e., non-passive) transmissions made from a short distance because of obstacles in the signal path, multi-path effects, and noise. For example, a “panic” alarm activation is preferably operative from the longest distance and with highest reliability achievable under cost, regulatory, and other system design constraints.

A similar solution for systems where the interrogatory transmissions are periodically sent from the base station is to decrease the power sent by the base station. But a uniform reduction in the transmitted power would also adversely affect the range and reliability of transmissions other than the passive remote control transmissions. For example, low-power transmissions sent in response to an event at the base station, such as an alarm condition, might not be received by the remote control device under conditions that would allow the device to receive similar high-power transmissions.

It would be advantageous to avoid the drawbacks of known systems while preserving transmission range and reliability of communications between the base station and the remote control device of a security system.

### SUMMARY

A need thus exists for reducing power consumption and transmission range of passive remote control commands issued by a remote control device, while preserving the transmission range of commands issued by the device in response to user inputs. A further need exists for reducing the range of base station interrogatory transmissions that enable passive operation of the security system, while preserving the range of other base station communications.

Aspects of the present invention are directed to methods, apparatus, and articles of manufacture that satisfy one or more of these needs. In some aspects, the invention herein disclosed is a security system that includes a base station and a remote control device capable of transmitting one or more commands to the base station. The remote control device is configured (1) to transmit using a first power level a command of the one or more commands in response to user input, and (2) to transmit automatically using a second power level at least an initial portion of command of the one or more commands. The second power level is lower than the first power level.

The one or more commands may include a plurality of active commands that are transmitted in response to user inputs. The one or more commands may include a command to unlock a door, disarm the security system, unlock the trunk, and/or start an engine, which command (or commands) may be transmitted both in response to user input and automatically as part of the passive remote control function of the system.

In some aspects the second power level is between about ten decibels and about 16 decibels lower than the first power level. In a more specific aspect, the differential is about 10 decibels. Similarly, the second power level may be set so that the transmission range from the remote control device to the base station is limited to under about 75 feet. In a more specific aspect, the transmission range is limited to under about 20 feet. The first power level may be set within 3 decibels of maximum transmitted power legally allowed for transmissions such as transmissions of the commands from the remote control device in response to user input. The invention should not be understood as necessarily limited to any specific power level, power level differential, or transmission range.

The remote control device may vary the second power level in response to changes in one or more operating parameters of the remote control device. The operating parameters affecting the second power level may include, for example, an indication of remaining life of the battery (e.g., battery voltage), movement of the remote control device, and time elapsed since a user of the device entered a command into the device.

The specific dependence of the second power level on these and other operating parameters, and on other variables, may be programmed into the system by the system's user or installer. Programming of the first and second power levels may be performed, for example, through a programming port of the remote control device, or via a base station interface and the wireless communications link between the base station and the remote control device.

Selected aspects of the invention are directed to a security system's base station and methods performed by the base station. In accordance with one aspect, a base station of a security system sends data to a remote control device of the security system using a first power level, and periodically sends an interrogatory transmission to the remote control device using a second power level. The second power level is lower than the first power level. When the interrogatory transmission is received by the remote control device, it triggers one or more responsive transmissions from the remote control device to the base station. The responsive transmissions may include a handshake between the remote control device and the base station. In the course of the handshake, the base station may send additional transmissions to the remote control device. In one aspect, base station's handshake transmissions to the remote control device are sent using the first power level.

When the base station receives the one or more responsive transmissions, it verifies the identity of the remote control device from information in the one or more responsive transmissions, and executes at least one command. The base station may identify the command from information in the responsive transmissions. Exemplary commands include a command to unlock a door of a vehicle, disarm the security system of the vehicle, and start the vehicle's engine.

One or both of the first and second power levels may be set when the base station receives the setting(s) from at least one of security system user and security system installer.

Embodiments of the invention further include memories and other machine-readable articles of manufacture with program code embedded therein. The code, when executed by a processor of the remote control device or of the base station, configures the device or the station (as the case may be) to perform the methods described above.

These and other features and aspects of the present invention will be better understood with reference to the following description, drawings, and appended claims.

### BRIEF DESCRIPTION OF THE FIGURES

FIG. 1 is a process flow diagram illustrating selected steps of a process for operating a multi-power mode remote control device of an automotive security system with passive remote control capability, in accordance with an embodiment of the present invention;

FIG. 2 is a high-level block diagram of a security system, in accordance with an embodiment of the present invention;

FIG. 3 is a high-level block diagram of the remote control of the security system of FIG. 2;

FIGS. 4, 5, and 6 are process flow diagrams illustrating selected steps of processes for operating a multi-power mode remote control device with interrupt-driven processing of user-entered and automatic remote control commands, in accordance with an embodiment of the present invention.

FIG. 7 is a process flow diagram illustrating selected steps of a process for operating a base station of an automotive security system with passive remote control capability and multi-power mode transmitter.

### DETAILED DESCRIPTION

In this document, including the appended claims, the words “embodiment” and “variant,” as well as similar expressions refer to particular apparatus or process, and not necessarily to the same apparatus or process. Thus, “one embodiment” or a similar expression used in one place or context can refer to a particular apparatus or process; the same or a similar expression in a different place can refer to a different apparatus or process. The expressions “alternatively,” “alternative embodiment,” and similar phrases are used to indicate one of a number of different possible embodiments. The number of potential embodiments is not necessarily limited to two or any other quantity. The words “couple,” “connect,” and similar expressions with their inflectional morphemes do not necessarily import an immediate or direct connection, but include connections through mediate elements within their meaning. “Operating parameters” or simply “parameters” refer to variable or variables that constitute the internal state of a remote control device and environmental factors affecting the remote control device. Other and further definitions and clarifications may be found elsewhere in this document. The definitions are intended to assist in understanding this disclosure and the appended claims, but the scope and spirit of the invention should not be construed as strictly limited to these definitions, or to the particular examples described in this specification.

The invention herein disclosed can be implemented as part or feature of a security system such as systems described in the following patent documents:

U.S. patent application entitled MENU-DRIVEN REMOTE CONTROL TRANSMITTER, filed on Oct. 30, 2003, application Ser. No. 10/699,009;

U.S. provisional patent application entitled SECURITY AND REMOTE ACCESS FOR VEHICULAR ENTERTAINMENT, SAFETY, AND CONVENIENCE SYSTEMS, filed on Jan. 2, 2004, application Ser. No. 60/533,942; and

U.S. patent Ser. No. 6,700,479.

Each of these commonly-assigned applications and patent is incorporated by reference herein in its entirety, including all figures, tables, claims, and matter incorporated by reference therein.

Reference will now be made in detail to several embodiments of the invention that are illustrated in the accompanying drawings. Same or similar reference numerals may be used in the drawings and the description to refer to the same or like apparatus elements and method steps. The drawings are in simplified form, not to scale, and omit apparatus elements and method steps that can be added to the described systems and methods, while including certain optional elements and steps.

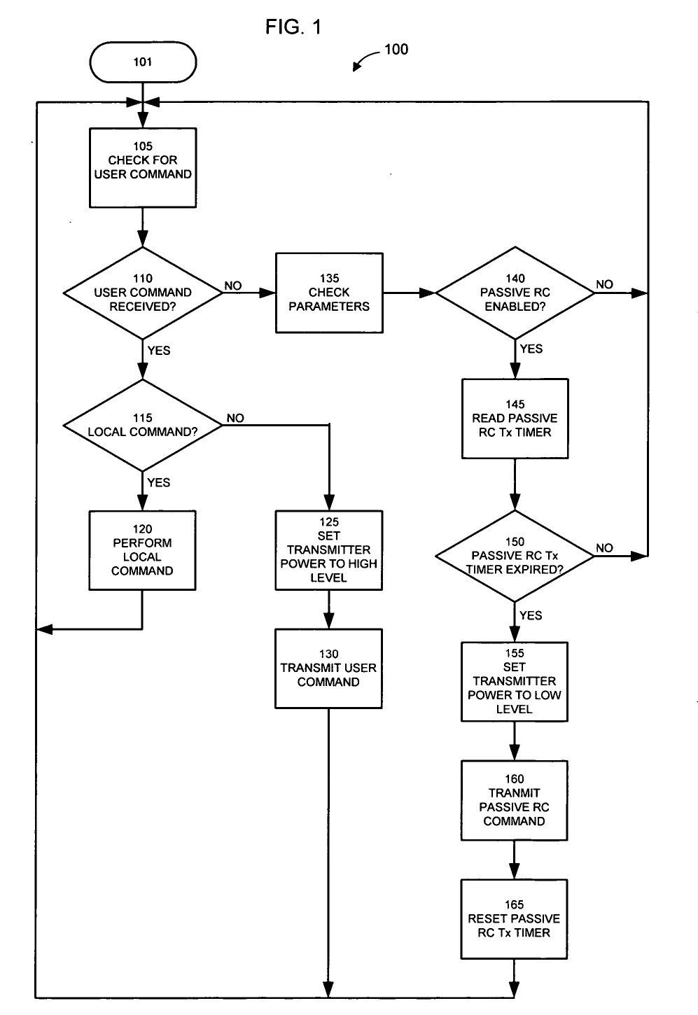

FIG. 1 is a process flow diagram illustrating selected steps and decision blocks of a process 100 for operating a multi-power mode remote control device of an automotive security system with passive remote control capability. Although certain process steps and decisions are described serially, some of these steps and decisions can be performed by separate elements in conjunction or in parallel, asynchronously or synchronously, in a pipelined manner, or otherwise. There is no particular requirement that the steps and decisions be performed in the same order in which this description lists them, except where explicitly so indicated, otherwise made clear from the context, or inherently required. Furthermore, not every illustrated step and decision is required in every embodiment in accordance with the invention, while some steps and decisions that have not been specifically illustrated may be desirable or necessary in some embodiments in accordance with the invention.

At flow point 101, the remote control device is ready to perform the steps of the process 100. At step 105, the remote control device checks (reads) an indicator that points out whether a user command has been received. The user may enter a command, for example, by pressing a key on the keypad of the remote control device. In performing the step 105, the device may, for example, check a register that latches indications that a key has been pressed. At decision block 110, the remote control device interprets the indicator to determine whether a command has indeed been entered by the user. If a command has not been entered, process flow proceeds to step 135. Otherwise, process flow proceeds to decision block 115.

In general, the commands are of two kinds: (1) local, and (2) remote. A remote command requires communication with the vehicle-installed base station of the security system. A local command does not require such communication. In the decision block 115, the remote control device determines whether the entered command is a local or a remote command. If the entered command is a local command, the remote control device performs the function or functions associated with the command, at step 120, and returns to the step 105. In the case of a remote command, the device configures its transmitter so that the transmitter will transmit at a relatively high power level. This is done in step 125.

As will be discussed in more detail below, the transmitter of the remote control device is capable of transmitting using two or more different power settings. For simplicity, two power level settings are discussed here: a high transmitted power level setting and a low transmitted power level setting. It should be noted that in the present context the “high” power level is high relative to the “low” power level, and vice versa. No specific absolute power level is implied by describing the power levels as either high or low. Thus, in the step 125 the transmitter is configured to transmit at a power level higher than at least one other power level at which the transmitter can transmit.

At step 130, the remote control device transmits to the base station the user command, or some information that has to be transmitted as part of performing the user command. At the same time, the remote control device may perform some other local operations associated with the command. Process flow then returns to the step 105.

Let us now return to the step 135, to which the process 100 branches when the decision block 110 indicates that no user command has been entered. At this step, the remote control device checks (reads) its internal state to determine whether passive remote control functionality has been enabled and is currently appropriate. For example, the user or installer may be able to configure the remote control device so that passive remote control is either enabled or disabled. As part of the step 135, the remote control device reads the programmed configuration variables affecting the passive remote control functionality.

Furthermore, passive remote control may be selected for only a limited set of operating parameters. In this regard, the use of a movement (motion) sensor built into the remote control device has already been described above. Advantageously, the present invention may employ such sensor to enhance battery life. For example, the remote control device may be configured to enable passive remote control functionality only within a predetermined time period of movement indicated by the movement sensor. Similarly, the remote control device may be configured to disable the passive remote control functionality if no user command has been entered within a predetermined time period, for example, 24 hours. In one process embodiment, the passive remote control functionality is totally disabled after battery voltage or another indication of remaining battery life drops below a predetermined level. Alternatively, the time period of inactivity after which the remote control functionality is disabled is shortened in response to falling indication of remaining battery life. As a person skilled in the art would understand after perusal of this document, these techniques for selectively disabling or modifying passive remote control functionality are not exclusive; other techniques and combinations of techniques may be used for this purpose. Whatever the parameters controlling availability of the passive remote control functionality are, they are read in the step 135.

At decision block 140, the remote control device determines, based on the parameters read in the step 135, whether the passive remote control functionality is enabled, and, therefore, whether passive transmissions of the remote control commands should be performed. If the parameters indicate that the transmissions should not be performed, process flow returns to the step 105. If the parameters indicate that the transmissions should be performed, process flow advances to step 145 to read the value of a passive remote control transmission timer.

At decision block 150, the remote control device determines whether the transmission timer has expired. If the timer has not expired, process flow returns once again to the step 105. If the timer has expired, indicating that a passive remote control command should be sent, process flow continues with step 155, in which the transmitter is configured to transmit at a relatively low power level. Again, the power setting is “low” in comparison to the “high” transmitter power setting of the step 125.

At step 160, the remote control device transmits a passive remote control command. In some embodiments, the command is a simple security system disarm directive. In other embodiments, the security system disarm directive is combined with another instruction, for example, a door unlock command or a command to start engine. Still other commands may be sent in other embodiments consistent with the invention.

At step 165, the remote control device resets the passive remote control transmission timer, so that the countdown to the next passive transmission begins anew. Process flow then returns to the step 105.

It should be noted that in the above description of the process 100, as well as throughout this document, including the appended claims, transmitting a command does not necessarily imply a single transmission. In some embodiments, the remote control device sends an interrogatory transmission and then listens for a response from the base station. If the base station receives the interrogatory transmission and recognizes a code embedded therein, it sends back a responsive handshake message acknowledging the receipt and authenticating the base station. The remote control device receives the response and then sends the appropriate instruction or other information, for example, a passive remote control instruction. The initial transmission may be active, i.e., user-initiated, or passive, i.e., made automatically and not in response to user input. In the context of the present document, a “command” sent by a remote control device refers to the interrogatory transmission, transmissions made in the course of the handshake process, and the actual instruction/directive that specifies the function to be performed by the base station. In embodiments where handshake is not implemented and interrogatory transmissions are not used, the word “command” refers to the actual instruction sent from the remote control device to the base station. The remote control device uses the low power level to make periodic transmissions to the base stations, for example, the interrogatory transmissions. Following the initial interrogatory transmission, the transmitter power level may be increased for transmission of the handshake and of the actual instruction.

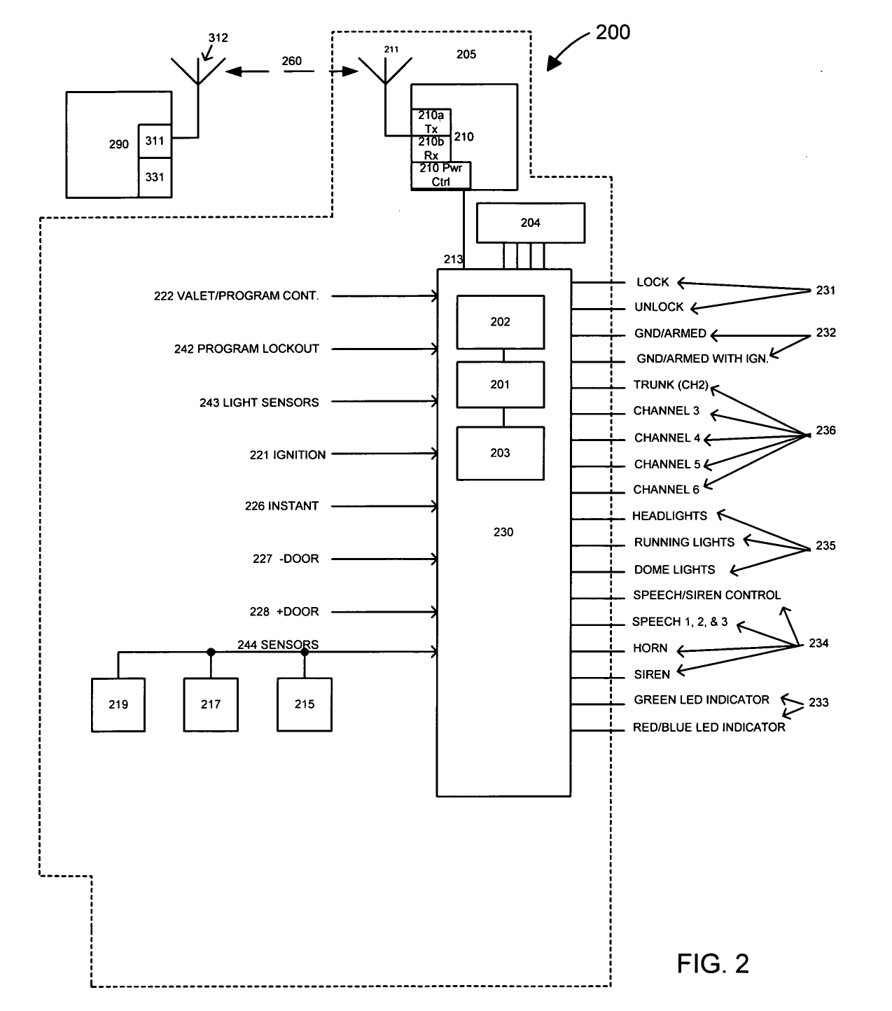

FIG. 2 is a simplified schematic diagram of a vehicle security system 200 that can perform the steps of the processes described in this document. As illustrated, the system incorporates a remote control device 290, wireless link 260, and base station 205 that includes the remaining components shown in FIG. 2 (appearing within the dotted lines). The remote control device 290 includes a variable output power transceiver 311, antenna 312, and processor subsystem (e.g., a controller) 331.

The base station 205 includes a base controller 230; a base transceiver 210 with its antenna 211; sensors 215, 217, and 219; and various additional inputs and outputs. The base controller 230 includes a processing unit 201, a non-volatile instruction memory 202, and operation memory 203. In the described embodiment, the base controller 230 is implemented as a microprocessor 201 with internal memory modules 202 (ROM) and 203 (RAM). As illustrated in FIG. 2, an external non-volatile memory device 204, such as an electrically erasable programmable read-only memory (EEPROM), can supplement the microprocessor memory, storing, for example, field-configurable control data and remote controller recognition codes.

The code of the program executed by the base controller 230 is normally embedded at the factory during the integrated circuit manufacturing process, but it can also be loaded or burned-in from a variety of sources in the field, for example, from a programming tool, machine-readable medium, such as a CD, DVD, flash memory, semiconductor ROM device, floppy or hard drive, or a similar memory or storage device. The code may also be loaded via a network, such as the Internet.

The base transceiver 210 communicates with the remote control device 290 over the link 260. Thus, the base controller 230, which is coupled to the transceiver 210 through interface line(s) 213, can communicate with the remote control device 290 through the base transceiver 210 and the link 260.

In the illustrated embodiment, the transceiver 210 includes a transmitter section 210a capable of transmitting commands and other data to the remote control device 290, a receiver section 210b capable of receiving data from the remote control device 290, and a power control section 210c that controls the power output level of the transmitter section 210a. The base controller 230 configures the power control section 210c through the interface line(s) 213.

In some embodiments, the transceiver 210 has a variable power transmitter capable of transmitting using two or more different power levels. One or more of the power levels may be user- or installer-configurable. In an embodiment, the transceiver 210 includes an AWICS-09325 IC-based RF Transceiver Module.

Although in the described embodiment the link 260 is shown as a bi-directional link, in some alternative embodiments the link 260 is unidirectional, carrying commands from the remote control device 290 to the base controller 230, but not in the opposite direction; in such embodiments, a simple receiver can perform the necessary functions in place of the transceiver 210.

The sensors of the described device 205 include a shock sensor 215, a field disturbance sensor 217, and a glass break sensor 219. Any other sensors appropriate to an automotive security system (or another installed environment) can be included as well.

Among the additional inputs to the base station 205 are these: +/− door inputs 228 and 227; a light sensor input 243; a valet/program control switch input 222; an ignition input 221; and a program lockout input 242, intended to prevent both accidental and intentional (subversive) programming of the base station 205, and programming of the remote control device 290 through the base station 205.

Lines 231 through 236 provide the following signal and control outputs:

Power door lock and unlock outputs—231;

Ground when armed and ground when armed-plus-ignition outputs for starter interrupt—232;

LED indicator outputs—233;

Speech, horn, and siren outputs for audible alarms and warnings—234;

Headlights, running lights, and dome light outputs—235; and

Channels 2 (trunk), 3, 4, 5, and 6 auxiliary outputs—236.

In a variant of the remote control system embodiment illustrated in FIG. 2, the base station includes remote start capability that uses additional inputs and outputs to enable the base station to start the vehicle. In this variant, the base station 205 further includes tachometer, neutral sense, brake activation, hood position, and remote starter activation outputs. Some of the added outputs are as follows: starter output; ignition output(s); and accessory output(s) for controlling the heater, air conditioner or other vehicle functions.

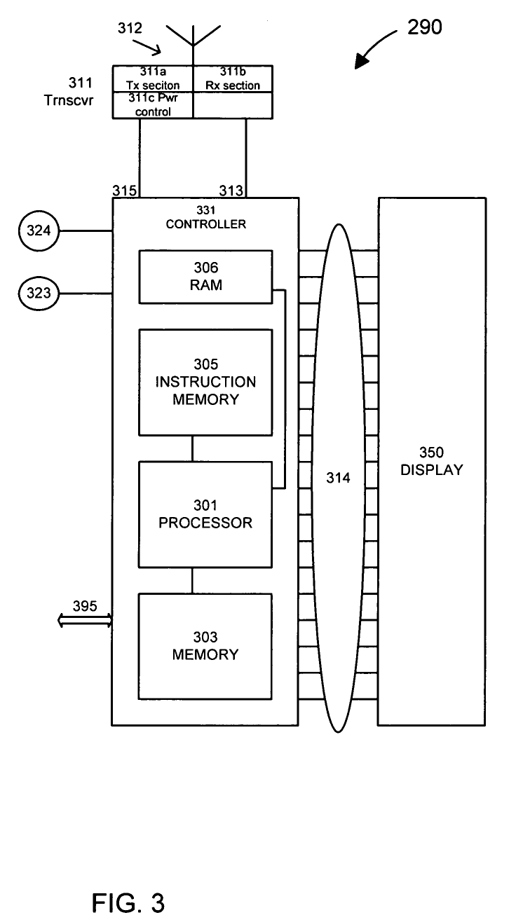

FIG. 3 illustrates a simplified block diagram of an embodiment of the remote control device 290 built on the platform of a controller 331, which can be, for example, a microcontroller (MCU), a microprocessor, or an application-specific integrated circuit. In the specific embodiment of FIG. 3, the controller 331 is a microcontroller. It includes a processing unit 301; random access memory 306 for use as operating registers, address registers, and for other data storage during program execution; and memory modules 303 and 305 for storing program instructions and data. The memory modules 303 and 305 can be, for example, read only memories (ROMs), programmable ROMs (PROMs), electrically programmable ROMs (EPROMs), and electrically erasable PROMs (EEPROMS). The memory module 305 is typically used to store program instructions and constants. In the embodiment of FIG. 3, the memory module 303 is a non-volatile, re-writable memory module, such as Flash, EEPROM, or low-power battery-backed memory. It is used to store programmable control and configuration data, such as transmitter identification code, icon definitions, and menu lists for the functional and operational routines of the remote control device 290.

The code of the program executed by the controller 331 is normally embedded at the factory during the integrated circuit manufacturing process, but it can also be loaded or burned-in from a variety of sources in the field, for example, from a programming tool, machine-readable medium, such as a CD, DVD, flash memory, semiconductor ROM device, floppy or hard drive, or a similar memory or storage device. The code may also be loaded via a network, such as the Internet.

Numeral 395 designates a port through which the remote control device 290 can receive its operating software and configuration parameters. In the embodiment of FIG. 3, the port 395 is a custom serial data port. In other embodiments, the port can be implemented, for example, as a Universal Serial Bus (USB); an RS 232 serial port; a parallel port; as a wired or wireless (e.g., IR, RF, ultrasound) network connection to a WAN (e.g., the Internet), LAN, intranet, or extranet; as a memory storage reader device; or as a receiver, transceiver, modem, or another communication interface device.

The controller 331 also has an input-output (I/O) section that provides the controller 331 with capability to read inputs and drive outputs under program control. The inputs of the I/O section of the controller 331 include connections to user-operable inputs 323 and 324, such as a scroll switch, a selection switch, and a keypad. The outputs of the I/O section further include the outputs 314 for driving a display 350; transceiver input/output lines 313 used to send data to and receive data from the base station 205 via the transceiver 311; and control interface lines 315 used to set the power level of the transmissions made by the transceiver 311. The control lines 315 may include a serial peripheral (SPI) interface. SPI is a synchronous serial data link that is standard across many Motorola microprocessors and other peripheral chips.

The display 350 is part of the user interface of the remote control device 290. It can be a graphical or an alphanumeric display.

The transceiver 311 can accept data for transmission to the transceiver 210 of FIG. 2. As mentioned previously, the link 260, over which the transmitter 290 and the transceiver 210 communicate, can be an RF, IR, ultrasound, or another kind of link. The nature of the link 260 dictates the specifics of the transceiver 311 and the transceiver 210. In an embodiment, the transceiver 311 includes an AWICS-09325 IC-based RF Transceiver Module.

The transceiver 311 includes a transmitter section 311a capable of transmitting commands and other data to the base station 205, a receiver section 311b capable of receiving data from the base station 205, and a power control section 311c that controls the power output level of the transmitter section 311a. The controller 331 configures the power control section 311c through one or more control interface lines 315. In some embodiments, the control interface lines 315 may be combined with the lines 313 as part of a single interface.

Two different transmitter power settings can be selected by the controller 331. In one embodiment, the high power level approaches (within 3 dB) the maximum transmitted power level allowed by rules of the Federal Communication Commission applicable to remote control devices of automotive security systems, while the low power level is such that the range of the remote control device 290 does not exceed about 75 feet (22.5 meters). In another embodiment, the low power level is set so that the range of the remote control device 290 does not exceed about 20 feet (6 meters). In yet another embodiment, the difference between the low power level and the high power level is about 10 decibels (dB). In still other embodiments, the difference between the low power level and the high power level is between about 10 dB and 16 dB. The broad concepts of the invention should not be construed as limited to any of these distances or decibel values. Furthermore, three or more transmitter power settings may be available in some embodiments.

It should be noted that the divisions between the sections 311a, 311b, and 311c are shown for illustration; the demarcation lines between these sections are quite arbitrary. Moreover, the power control section may also perform other control functions within the transceiver 311, and may be tightly coupled to both the transmitter section 311a and the receiver section 311b. In some embodiments, the control of transmitted power is achieved through reduction of power supplied to the transmitter section 311a. Two or more transmitter power settings are available for selection by the controller 331. In various embodiments, one or more of these power levels may be user- or installer-configurable within predetermined limits. For example, the low power level may be allowed to vary within broad limits to accommodate the user's specific preference of balance between battery conservation and range of passive remote control command transmissions.

The process 100 is of course exemplary and not uniquely required for practice of the invention, as is the case with other process and apparatus embodiments described in this document. Many other variations on the multi-power mode transmission technique will surely occur to a person skilled in the art after perusal of this document. To illustrate, an additional embodiment of a multi-power mode remote control device is described below.

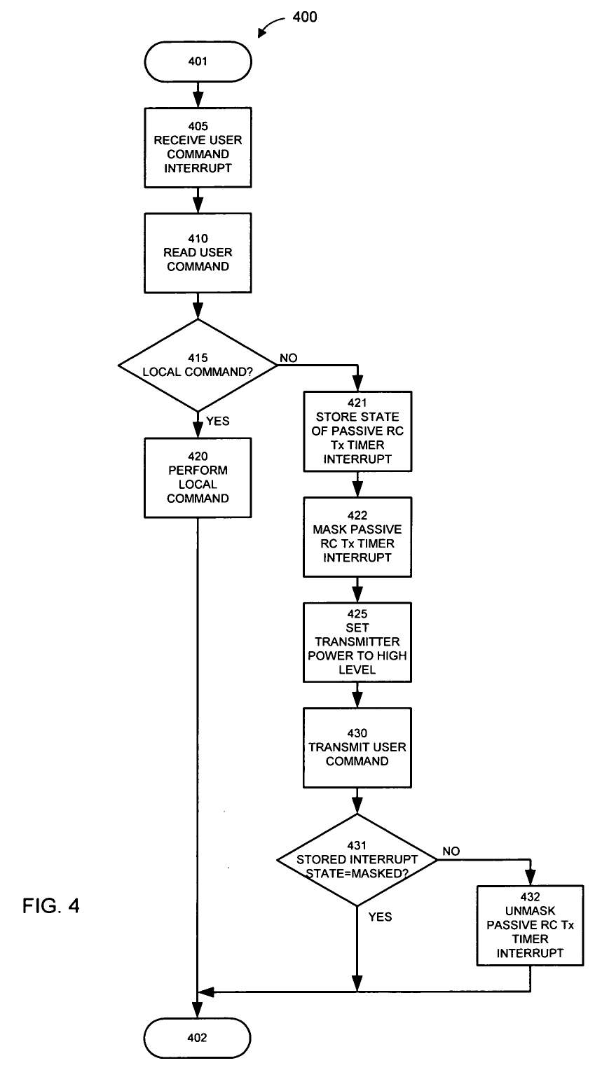

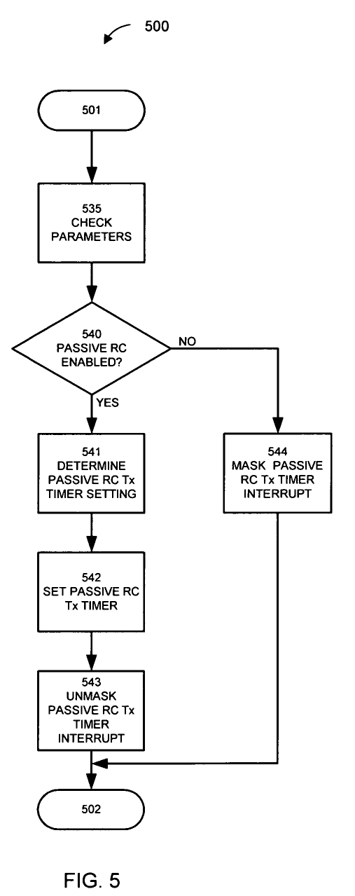

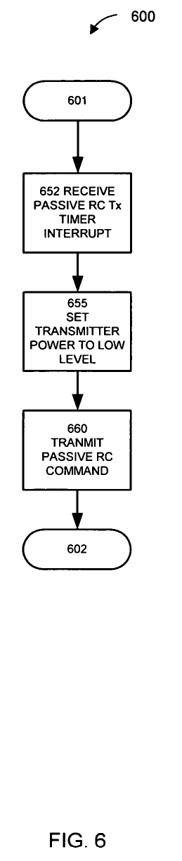

FIGS. 4, 5, and 6 are process flow diagrams illustrating selected steps and decision blocks of processes 400, 500, and 600 for operating a multi-power mode remote control device with interrupt-driven processing of user-entered and passive remote control commands. Although certain process steps and decisions are described serially, some of these steps and decisions can be performed by separate elements in conjunction or in parallel, asynchronously or synchronously, in a pipelined manner, or otherwise. There is no particular requirement that the steps and decisions be performed in the same order in which this description lists them, except where explicitly so indicated, otherwise made clear from the context, or inherently required. Furthermore, not every illustrated step and decision is required in every embodiment in accordance with the invention, while some steps and decisions that have not been specifically illustrated may be desirable or necessary in some embodiments in accordance with the invention.

The process 400 is an interrupt-driven (interrupt-initiated) process for sending a user-entered command, i.e., an active command. It begins at flow point 401 with the remote control device being previously initialized and ready for operation. At step 405, the controller of the remote control device receives an interrupt from the user interface of the remote control device, such as the user-operable inputs 323/324. At step 410, the device identifies the specific command entered by the user. At decision block 415, the remote control device determines whether the command is a local command. If the command is a local command, process flow proceeds to step 420 to perform the local command. After the step 420, the process 400 terminates at flow point 402.

If the remote control device determines, at the decision block 415, that the entered command is not a local command, i.e., it is a remote command, process flow branches to step is 421 to read and store the state of the passive remote control transmit timer interrupt (masked or unmasked). At step 422, the passive remote control transmit timer interrupt is masked. The passive remote control transmit timer interrupt results from expiration of the passive remote control transmit timer, which is analogous to the similarly named timer previously described in relation to FIG. 1. The reason for masking the passive remote control transmit timer interrupt is to prevent passive (automatic) transmissions to the base from disrupting or delaying transmissions due to user commands.

At step 425, the remote control device configures its transmitter so that the transmitter will transmit at a relatively high power level.

At step 430, the remote control device transmits to the base station the user command, or some information that has to be transmitted as part of performing the user command.

At decision block 431, the device determines whether the passive remote control transmit timer interrupt was masked before the step 422. If the interrupt was masked, process flow terminates at the flow point 402. Otherwise, the device unmasks the interrupt at step 432 to enable automatic transmissions to the base station. Process flow then terminates at the flow point 402.

The process 500 may be performed in response to a change in any of the operating parameters of the remote control device. Recall that the parameters may change, for example, when the device is being moved, when the movement ceases, or when the battery voltage falls below a predetermined threshold. Beginning with flow point 501, the process flow proceeds to step 535 to read the parameters. At decision block 540, the remote control device determines, based on the parameters read in the step 535, whether the passive remote control functionality is enabled, and, therefore, whether automatic transmissions of the passive remote control commands should be performed. If the parameters indicate that the transmissions should be performed, process flow advances to step 541 to determine an appropriate setting for the passive remote control transmit timer. Recall that this setting may be a function of the operating parameters. At step 542, the device sets the timer in accordance with the determination of the step 541, and, at step 543, unmasks the passive remote control transmission interrupt. After the interrupt is unmasked, process flow terminates at the flow point 502.

If the determination made at the decision block 540 indicates that passive remote control functionality should be disabled, the remote control device proceeds to step 544 to mask the passive remote control transmit timer interrupt. Process flow then terminates at the flow point 502.

The process 600, which sends the automatic (passive) remote control commands, begins at flow point 601. At step 652, the remote control device receives the passive remote control transmit timer interrupt occasioned by expiration of the passive remote control transmit timer. At step 655, the device configures the transmitter to transmit at a relatively low power level. At step 660, the device transmits the passive remote control command at the low power level. The process 600 then terminates at flow point 602.

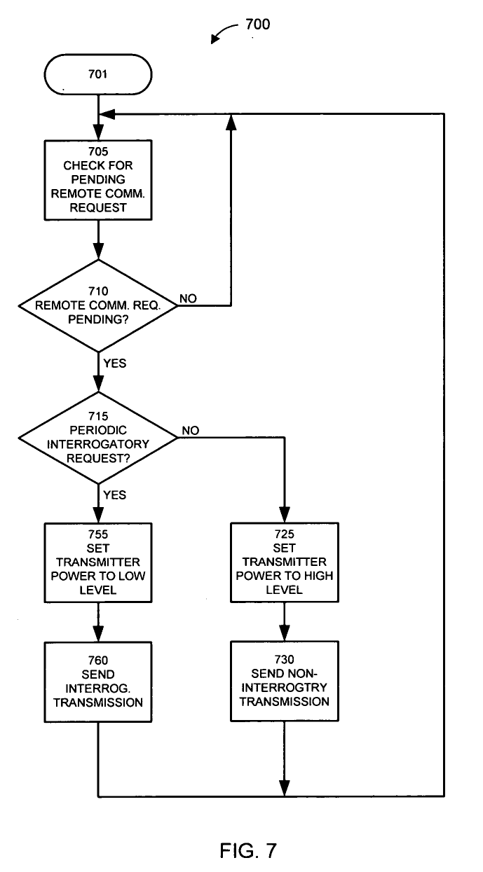

Turning now to an embodiment in which the base station sends interrogatory transmissions, FIG. 7 is a process flow diagram illustrating selected steps and decision blocks of a process 700 for operating a base station of an automotive security system with passive remote control capability and multi-power mode transmitter. Although certain process steps and decisions are described serially, some of these steps and decisions can be performed by separate elements in conjunction or in parallel, asynchronously or synchronously, in a pipelined manner, or otherwise. There is no particular requirement that the steps and decisions be performed in the same order in which this description lists them, except where explicitly so indicated, otherwise made clear from the context, or inherently required. Furthermore, not every illustrated step and decision is required in every embodiment in accordance with the invention, while some steps and decisions that have not been specifically illustrated may be desirable or necessary in some embodiments in accordance with the invention.

At flow point 701, the base station is initialized and ready to communicate with the remote control device.

At step 705, the base station checks its internal state to identify any pending remote communication requests. For example, the base station may (1) read registers that latch newly-originated alarm conditions (e.g., zone violations) and other externally-driven events, (2) read the passive remote control transmit timer that controls periodic interrogatory transmissions, and (3) read registers that contain other pending transmissions to be sent to the remote control device, such as handshake transmissions.

At decision block 710, the base station determines whether a remote communication request is pending. If there are no current remote communication requests, process flow returns to the step 705. Otherwise, the base station determines, at decision block 715, whether the pending communication request that is being processed corresponds to an interrogatory transmission used for passive remote control.

If the pending remote communication request corresponds to an interrogatory transmission used for passive remote control, the base station advances from the decision block 715 to step 755 to configure the base station transmitter to transmit at a relatively low power level.

Note that the transmitter of the base station is capable of transmitting using two or more different power level settings, as was the case with the transmitter of the remote control device used to perform the process 100 discussed above. For simplicity, two power level settings are discussed here: a high transmitted power level setting and a low transmitted power level setting. The “high” power level is high relative to the “low” power level, and vice versa. No specific absolute power level is implied by describing the power levels as either high or low.

After the transmitter is configured for low power transmissions, the base station sends the interrogatory transmission. Process flow then returns to the step 705 at the beginning of the process 700.

If the pending remote communication request does not correspond to a passive remote control interrogatory transmission, as determined in the decision block 715, the base station proceeds to step 725. Here, the base station configures its transmitter to transmit at a relatively high power level, i.e., at a power level higher than that of step 755. After the transmitter is configured for high power transmissions, the base station sends the transmission corresponding to the pending remote communication request, at step 730. Process flow then returns once again to the step 705.

In operation, the base station continually examines its internal state to determine whether remote communication requests are pending. A pending remote communication request is a need to send a transmission from the base station. If the pending request is a request to send an interrogatory transmission to the remote control device for the purpose of enabling passive remote control, the base station configures its transmitter to transmit at a relatively low power level. For at least some other remote communication requests, the base station configures the transmitter to transmit at a relatively high power level. The base station then transmits using the selected power level. Thus, the effective range of the interrogatory transmissions is shorter than the effective range of other transmissions, for example, transmissions communicating alarm conditions to the remote control device of the security system.

In some embodiments the second power level is between about ten decibels and about sixteen decibels lower than the first power level. In a more specific embodiment, the differential is about 10 decibels. Similarly, the second power level may be set so that the transmission range from the base station to the remote control device is limited to under about 75 feet. In a more specific embodiment, the transmission range is limited to under about 20 feet. The first power level may be set within 3 decibels of maximum transmitted power legally allowed for transmissions such as transmissions from the base station to the remote control device. The invention should not be understood as necessarily limited to any specific power level, power level differential, or transmission range.

In some embodiments, the system remote control device can be configured to recognize a reading of a signal strength indicator (SSI) as an indication of the distance from the base station. Likewise, the system base station can be configured to recognize an SSI reading as an indication of the distance from the remote control device and to disarm or not disarm the system based on the SSI level when the system is in the passive recognition mode. Even if both the base station and the remote control device have multi-power levels and the power level indicator is embedded and transmitted in the code word, each unit can be configured to recognize the SSI level as an indication of distance from the other device.

This document describes the inventive apparatus, methods, and articles of manufacture enabling multi-power mode functionality in considerable detail. This was done for illustration purposes only. Neither the specific embodiments of the invention as a whole, nor those of its features limit the general principles underlying the invention. The specific features described herein may be used in some embodiments, but not in others, without departure from the spirit and scope of the invention as set forth. Various physical arrangements of components and various step sequences also fall within the intended scope of the invention. Furthermore, the invention need not be limited to automotive or vehicular applications, but may extend to applications involving other kinds of security and convenience systems, and beyond. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is carried out by the claims and their equivalents.

What is claimed is:

1. A security system comprising:
a base station; and
a remote control device capable of transmitting one or more commands to the base station;
wherein:
the remote control device is configured to perform step comprising:
transmitting using a first power level a command of said one or more commands in response to user input, and
transmitting automatically using a second power level at least an initial portion of a command of said one or more commands, the second power level being lower than the first power level.

2. A security system according to claim 1, wherein said one or more commands comprise a plurality of active commands that are transmitted in response to user input.

3. A security system according to claim 1, wherein said one or more commands comprise a command to unlock a door, said command transmitted in response to user input comprises said command to unlock a door, and said command transmitted automatically comprises said command to unlock a door.

4. A security system according to claim 1, wherein:
said one or more commands comprise a command to disarm the security system;
said command transmitted in response to user input comprises said command to disarm the security system; and
said command transmitted automatically comprises said command to disarm the security system.

5. A security system according to claim 1, wherein:
the remote control device comprises a battery;
the remote control device varies the second power level as a function of an indication of remaining life of the battery; and
the remote control device stops performing the step of transmitting automatically when remaining life of the battery falls below a predetermined level.

6. A security system according to claim 1, wherein the second power level is programmable by at least one of security system user and security system installer.

7. A security system according to claim 1, wherein:
the remote control device comprises a movement sensor; and
the remote control device varies the second power level in response to movement of the remote control device.

8. A security system according to claim 1, wherein the remote control device varies the second power level in response to change in at least one operating parameter of the remote control device.

9. A security system according to claim 1, wherein the remote control device varies the second power level as a function of time elapsed since a user of the device entered a command into the device.

10. A security system according to claim 1, wherein the base station is designed for installation in an automobile.

11. A remote control device for sending commands to a base station, the device comprising:
a memory storing program code;
a transmitter capable of sending commands to the base station using a plurality of power levels, the plurality of power levels comprising a first power level and a second power level that is lower than the first power level;
a user-operable input device; and
a controller coupled to the memory, the transmitter, and the user-operable input device, the controller being capable of executing the program code to control the transmitter and to receive user input through the user-operable input device;
wherein the controller executing the program code is capable of causing the transmitter to perform steps comprising:
transmitting a command using the first power level in response to the user input received from the user-operable input device, and
transmitting automatically at predetermined times at least initial portion of a command using the second power level.

12. A remote control device according to claim 11, wherein the controller is capable of causing the transmitter to transmit a plurality of different commands using the first power level in response to the user input.

13. A remote control device according to claim 11, wherein:
the command transmitted using the first power level in response to the user input comprises a command to unlock a door of an automobile; and
the command transmitted automatically comprises the command to unlock a door.

14. A remote control device according to claim 11, wherein:
the command transmitted using the first power level in response to the user input comprises a command to disarm a security system; and
the command transmitted automatically comprises the command to disarm the security system.

15. A remote control device according to claim 11, further comprising a battery, wherein:
the controller varies the second power level as a function of an indication of remaining life of the battery; and
the controller stops performing the step of transmitting automatically when remaining life of the battery falls below a predetermined level.

16. A remote control device according to claim 11, wherein the second power level is programmable by at least one of user of the remote control device and installer of the base station.

17. A remote control device according to claim 11, further comprising a movement sensor, wherein the controller varies the second power level in response to movement of the remote control device.

18. A remote control device according to claim 11, wherein the controller varies the second power level in response to change in at least one operating parameter of the remote control device.

19. A remote control device according to claim 11, wherein the controller varies the second power level as a function of time elapsed since a user of the device entered a command into the device.

20. A remote control device according to claim 11, wherein the base station comprises an automotive security system base station.

21. A method of operating a remote control device capable of transmitting commands to a base station, the method comprising:
transmitting one or more commands using a first power level from the remote control device to the base station, each command of the one or more commands being transmitted in response to user input entered at the remote control device; and
automatically transmitting at a plurality of times at least initial portion of a command using a second power level, from the remote control device to the base station;
wherein the second power level is different from the first power level.

22. A method of operating a remote control device according to claim 21, further comprising receiving the user input.

23. A method according to claim 22, wherein said one or more commands comprise a plurality of active commands that are transmitted in response to the user input.

24. A method according to claim 22, wherein:
the base station comprises an automotive security system;
said one or more commands comprise a command to unlock an automobile door; and
said automatically transmitted command comprises said command to unlock an automobile door.

25. A method according to claim 22, wherein:
the base station comprises an automotive security system;
said one or more commands comprise a command to disarm the security system; and
said automatically transmitted command comprises said command to disarm the security system.

26. A method according to claim 22, wherein the remote control device comprises a battery, the method further comprising:
receiving indications of remaining life of the battery; and
varying the second power level as a function of the indications;
wherein the step of automatically transmitting is terminated when remaining life of the battery falls below a predetermined level.

27. A method according to claim 22, further comprising varying the second power level in accordance with programming provided by at least one of security system user and security system installer.

28. A method according to claim 22, further comprising varying the second power level in response to movement of the remote control device.

29. A method according to claim 22, further comprising varying the second power level in response to changes in at least one operating parameter of the remote control device.

30. A method according to claim 22, further comprising varying the second power level as a function of time elapsed since a user of the device entered a command into the device.

31. A method according to claim 22, wherein the base station is designed for installation in an automobile.

32. An article of manufacture comprising machine-readable storage medium with program code stored in the medium, the program code, when executed by a controller of a remote control device comprising a user-operable input device and a transmitter capable of sending commands to the base station using a plurality of power levels, the plurality of power levels comprising at least a first power level and a second power level that is lower than the first power level, is capable of causing the controller to configure the remote control device to perform steps comprising:
receiving user input from the user-operable input device;
transmitting a command using the first power level in response to the user input; and
transmitting automatically at a plurality of times at least initial portion of a command using the second power level.

33. An article of manufacture according to claim 32, wherein the program code, when executed by the controller, is capable of causing the controller to configure the remote control device to transmit a plurality of different commands using the first power level in response to the user input.

34. An article of manufacture according to claim 32, wherein the program code, when executed by the controller, is capable of causing the controller to configure the remote control device to
cause the command transmitted using the first power level in response to the user input to comprise a command to unlock a door of an automobile; and
cause the command transmitted automatically to comprise the command to unlock a door.

35. An article of manufacture according to claim 32, wherein the program code, when executed by the controller, is capable of causing the controller to configure the remote control device to
cause the command transmitted using the first power level in response to the user input to comprise a command to disarm a security system; and
cause the command transmitted automatically to comprise the command to disarm the security system.

36. An article of manufacture according to claim 32, wherein:
the remote control device further comprises a battery;
the program code, when executed by the controller, is capable of causing the controller to configure the remote control device to vary the second power level as a function of an indication of remaining life of the battery; and
the program code, when executed by the controller, is capable of causing the controller to configure the remote control device to stop performing the step of transmitting automatically when remaining life of the battery falls below a predetermined level.

37. An article of manufacture according to claim 32, wherein:
the remote control device further comprises a movement sensor; and
the program code, when executed by the controller, is capable of causing the controller to configure the remote control device to allow the second power level to be programmable by at least one of a user of the remote control device and an installer of the base station.

38. An article of manufacture according to claim 32, wherein the program code, when executed by the controller, is capable of causing the controller to configure the remote control device to vary the second power level in response to movement of the remote control device.

39. An article of manufacture according to claim 32, wherein the program code, when executed by the controller, is capable of causing the controller to configure the remote control device to vary the second power level in response to change in at least one operating parameter of the remote control device.

40. An article of manufacture according to claim 32, wherein the program code, when executed by the controller, is capable of causing the controller to configure the remote control device to vary the second power level as a function of time elapsed since a user of the device entered a command into the device.

41. A security system comprising:
a remote control device; and
a base station comprising a transceiver capable of transmitting at a first power level and a second power level that is lower than the first power level, a memory storing program code, and a controller coupled to the transceiver and the memory, the controller being capable of executing the program code, wherein the controller executing the program code is capable of performing steps comprising:
sending data to the remote control device using the first power level;
sending an interrogatory transmission to the remote control device using the second power level, the interrogatory transmission, when received by the remote control device, triggering one or more responsive transmissions from the remote control device to the base station;
receiving from the remote control device the one or more responsive transmissions;
verifying identity of the remote control device from the one or more responsive transmissions; and
executing at least one command after the step of verifying.

42. A security system according to claim 41, wherein the steps performed by the controller executing the program code further comprise:
identifying the at least one command from information in the one or more responsive transmissions.

43. A security system according to claim 41, wherein the at least one command comprises a command to unlock a door.

44. A security system according to claim 41, wherein the at least one command comprises a command to disarm the security system.

45. A security system according to claim 41, wherein the at least one command comprises a command to start engine of a vehicle in which the base station is installed.

46. A security system according to claim 41, wherein the second power level is programmable by at least one of security system user and security system installer.

47. A security system according to claim 41, wherein the base station is designed for installation in an automobile.

48. A security system according to claim 41, wherein the data sent by the controller to the remote control devices comprises alarm data.

49. A security system according to claim 41, wherein the step of verifying comprises sending to the remote control device a handshake transmission using the first power level.

50. A security system according to claim 41, wherein the controller periodically repeats the step of sending an interrogatory transmission.

51. An article of manufacture comprising machine-readable storage medium with program code stored in the medium, the program code, when executed by a controller of an automotive security system base station, the base station comprising the controller and a transceiver coupled to the controller, is capable of causing the controller to perform steps comprising:
configuring the transceiver to transmit at a plurality of power levels comprising at least a first power level and a second power level, the second power level being lower than the first power level;
sending data to a remote control device of the security system using the first power level;
sending an interrogatory transmission to the remote control device using the second power level, the interrogatory transmission, when received by the remote control device, triggering one or more responsive transmissions from the remote control device to the base station;
receiving from the remote control device the one or more responsive transmissions;
verifying identity of the remote control device from the one or more responsive transmissions; and
executing at least one command after the step of verifying.

52. An article of manufacture according to claim 51, wherein the program code, when executed by the controller, is further capable of causing the controller to perform steps comprising:
identifying the at least one command from information in the one or more responsive transmissions.

53. An article of manufacture according to claim 51, wherein the at least one command comprises a command to unlock a door.

54. An article of manufacture according to claim 51, wherein the at least one command comprises a command to disarm the security system.

55. An article of manufacture according to claim 51, wherein the at least one command comprises a command to start engine of a vehicle in which the base station is installed.

56. An article of manufacture according to claim 51, wherein the data comprises alarm data.

57. An article of manufacture according to claim 51, wherein the step of verifying comprises sending to the remote control device a handshake transmission using the first power level.

58. A security system according to claim 51, wherein the program code, when executed by the controller, is further capable of causing the controller to repeat periodically the step of sending an interrogatory transmission.

59. A method of operating a base station of a security system, the method comprising:
sending data from the base station to a remote control device of the security system using a first power level;
sending an interrogatory transmission to the remote control device using a second power level that is lower than the first power level, the interrogatory transmission, when received by a remote control device of the security system, triggering one or more responsive transmissions from the remote control device to the base station;
receiving from the remote control device the one or more responsive transmissions;
verifying identity of the remote control device from information in the one or more responsive transmissions; and
executing at least one command after the step of verifying.

60. A method according to claim 59, further comprising:
identifying the at least one command from information in the one or more responsive transmissions.

61. A method according to claim 59, wherein the step of executing comprises executing a command to unlock a door.

62. A method according to claim 59, wherein the step of executing comprises executing a command to disarm the security system.

63. A method according to claim 59, wherein the step of executing comprises executing a command to start engine of a vehicle in which the base station is installed.

64. A method according to claim 59, further comprising:
receiving a setting for the second power level from at least one of security system user and security system installer.

65. A method according to claim 59, wherein the base station is designed for installation in an automobile.

66. A method according to claim 59, wherein the step of sending data comprises sending alarm data to the remote control device using the first power level.

67. A method according to claim 59, wherein the step of sending data comprises sending a handshake transmission to the remote control device using the first power level.

68. A method according to claim 59, further comprising periodically repeating the step of sending an interrogatory transmission.
